(19) United States
(12) Patent Application Publication
(10) Pub. No.: US 2015/0342214 A1
(43) Pub. Date: Dec. 3, 2015

(54) PROCESS FOR PROVIDING A COCOA REPLACER BASED ON A MATERIAL SELECTED FROM ROASTED WHEAT, ROASTED AND/OR MALTED BARLEY

(71) Applicant: Givaudan, S.A., Vernier (CH)

(72) Inventors: Esther VAN OMMEREN, Almere (NL); Guiseppe CORDA, Baarn (NL); Jan BAKKER, Nijkerk (NL); Caroline DAHAN, Annecy le Vieux (FR)

(21) Appl. No.: 14/821,235

(22) Filed: Aug. 7, 2015

Related U.S. Application Data
(63) Continuation-in-part of application No. 14/390,531, filed on Oct. 3, 2014.

(30) Foreign Application Priority Data
Apr. 4, 2012 (GB) 1206035.6

(51) Int. Cl. A23G 1/48; A23G 1/34

(52) U.S. Cl. CPC A23G 1/48; A23G 1/34; A23V 2002/00

(57) ABSTRACT

A process for providing a cocoa replacer based on a material selected from roasted wheat, roasted and/or malted barley, including the steps of
(a) addition of the roasted wheat, roasted and/or malted barley to water at an initial temperature of at least 65° C. in an evaporation vessel;
(b) maintaining the initial temperature for at least 30 minutes;
(c) adding cold water; and
(d) immediately spray-drying the solution to give the cocoa replacer;
   wherein the quantity of water in step (a) is such that the weight of the roasted wheat, roasted and/or malted barley material comprises from 12-22% of the total weight of the material and water, and the quantity of water in step (c) comprises from 25-40% of the total quantity of water used in the process. The resulting powder is dark in colour and can be used to replace a proportion of cocoa without a loss of flavour and with no undesirable after-taste.

The present application is a continuation-in-part of U.S. Ser. No. 14/390,531, having a 35 U.S.C. 371 date of Oct. 3, 2014, which is a national stage filing of international patent application PCT/EP2013/057109, filed 4 Apr. 2013, which claims priority from Great Britain Patent Application No. 1206035.6, filed 4 Apr. 2012, from which applications priority is claimed, and which are incorporated herein by reference.

This disclosure relates to a cocoa replacer and to a method of making such a replacer.

Cocoa is a desirable flavour in many comestible products. However, cocoa beans are a commodity whose price varies considerably, and in times of shortage, it can become relatively expensive, which cost has to be passed on to the consumer. It is therefore desirable that a flavour material that can at least partially replace genuine cocoa can be found. Such materials are already well known. Examples of suitable materials that can at least partially replace cocoa include roasted wheat, malted and/or roasted barley and carob powder. While these have been used extensively and quite successfully commercially, they have certain drawbacks. One of these is the difficulty of achieving the appropriate dark colour. A greater problem is the aftertaste associated with many of these materials. For example, black malted barley, one of the more popular cocoa replacers, exhibits characteristic strong off-tastes (described variously as “smoky” and “ashy”), plus a lack of the desired bitterness and astringency necessary for a good cocoa flavour.

It has now been found that it is possible to treat these cocoa replacers in such as way that these undesirable characteristics can be considerably reduced. There is therefore provided a process for providing a cocoa replacer based on a material selected from roasted wheat, roasted and/or malted barley, comprising the steps of
(a) addition of the roasted wheat, roasted and/or malted barley to water at an initial temperature of at least 65° C. in an evaporation vessel;
(b) maintaining the initial temperature for at least 30 minutes;
(c) adding cold water; and
(d) immediately spray-drying the solution to give the cocoa replacer;
   wherein the quantity of water in step (a) is such that the weight of the roasted wheat, roasted and/or malted barley material comprises from 12-22% of the total weight of the material and water, and the quantity of water in step (c) comprises from 25-40% of the total quantity of water used in the process.

There is also provided a cocoa replacer with reduced off-taste, prepared by the method as hereinabove described.

Cocoa replacers based on roasted wheat and malted and/or roasted barley (hereinafter “the raw materials”) are well-known and readily-available items of commerce, and any such material can be used in the process.

It is important that the initial mixing in water be performed in an evaporation vessel, that is, a vessel that permit evaporations. This is typically an open vessel or a closed vessel under vacuum. Both are well known to the art. The water used is ordinary tap water. The quantity of water used is such that the weight of the roasted wheat, roasted and/or malted barley material comprises from 12-22% of the total weight of the material and water. In a particular embodiment, the weight of the roasted wheat, roasted and/or malted barley material in the water is from 14-18%, more particularly from 15-17%, of the total weight of the material and water.

In the process, the water is initially heated to at least 65° C. The temperature can be up to 95° C., and in a particular embodiment it is in the region of 90° C. It is maintained at this temperature during and after the addition of the raw materials. It is natural that the temperature will fall to under the initial heating temperature when the raw materials are added, but this is not critical, so long as the temperature is returned to at least that initial temperature as soon as possible. This temperature is maintained for 20 to 70 minutes, particularly 30 minutes. Further water is then added, the quantity of this water being from 25 to 40% of the total quantity of water used in the process, particularly from 25 to 35%, more particularly from 28-32%. This complete mixture is then spray-dried, using conventional methods and equipment.

When this last-named water addition (step (d)) is made, it is also possible to add at this point at least one further flavour ingredient, to give a desired flavour, in addition to the cocoa flavour. The desired flavours include chocolate, cocoa, vanilla, nuts and umami. The skilled flavourist can regulate the nature and proportion of such ingredients to create the nature and extent of the additional flavour. Such flavours are well known to and widely used by the art, and typical specific (and non-limiting) examples include pyrazines, phenyl ethyl esters, phenyl ethyl alcohols, phenyl ethyl aldehydes, pentanal, isopentanal and vanillin.

The resulting cocoa replacer has an agreeably dark colour and can be used to replace real cocoa at a proportion of up to 70% but particularly between 5 and 50%, more particularly from 15-50% by weight. It is possible to work outside these ranges, and in some circumstances it is even appropriate, but in general the benefits of such proportions are considerably reduced.

The resulting modified cocoa tastes the same as full-strength cocoa powder. It has desired astringency and bitterness, and is substantially lacking in the undesirable off-notes of commercially-available cocoa replacers. It can be used in any application in which cocoa is normally used, for example, beverages, baking, dairy and confectionery.

The disclosure is further described with reference to the following non-limiting example.

### EXAMPLE 1

### Preparation of a Cocoa Replacer.

1300 g. tap water is heated to 90° C. in an open, jacketed vessel.
250 g. roasted malted barley is added with stirring.
stirring is continued for 30 minutes while the temperature is maintained at 90°
after the 30 minutes is concluded, additional water is added including flavour and taste ingredients, and the dispersion of roasted malted barley plus flavour and taste ingredients in water is spray-dried to give a dark-brown powder. The temperature of the drying air is 220° C. The temperature of the air leaving the spray dryer is 85° C.

### EXAMPLE 2

A chocolate milk drink was prepared as follows:

Recipe—Reference with 2% Brown Cocoa Powder

| Ingredient | % |
|---|---|
| Half-fat milk, pasteurized | 90.96 |
| Brown cocoa powder | 2 |
| Sugar | 7 |
| Carrageenan | 0.04 |
| TOTAL | 100 |

The same chocolate milk drink was prepared, with the exception that the cocoa powder was replaced by the same proportion of a blend of cocoa powder and the product of Example 1, in which the product of Example 1 was present to the extent of 30% of the mixture.

The drinks were sampled by a tasting panel of 10 expert testers, plus a sensory test with 60 panellists. The testers noted no difference in colour and all found the taste of the two drinks to be substantially identical.

### EXAMPLE 3

Chocolate cookies were baked according to the following recipe:

Recipe—Reference with 5% Black Cocoa Powder

| Ingredient | % |
|---|---|
| Flour 10-11% Protein | 47.5 |
| Malto Dextrin MD 10 | 1 |
| Sodium Acid Pyrophosphate (SAPP) | 0.3 |
| Black cocoa powder | 5 |
| Sugar | 20 |
| Shortening | 18 |
| Salt | 0.5 |
| Sodium Bicarbonate | 0.35 |
| Ammonium-, Bicarbonate | 0.05 |
| Skimmed milk powder | 0.6 |
| Water | 6.7 |
| TOTAL | 100 |

The same cookies were prepared, with the exception that the cocoa powder was replaced by the same proportion of a blend of cocoa powder and the product of Example 1, in which the product of Example 1 was present to the extent of 30% of the mixture.

The cookies were sampled by a tasting panel of 10 expert testers. The testers noted no difference in colour and all found the taste of the two batches of cookies to be substantially identical.

### EXAMPLE 4

A breakfast cereal was prepared according to the following recipe:

Recipe Cereals—Reference with 5% Brown Cocoa Powder

| Ingredient | % |
|---|---|
| Maize Grits | 60 |
| Oat flour | 29 |
| Brown cocoa powder | 5 |
| Sugar | 5 |
| NaCl | 1 |
| TOTAL | 100 |

The same cereal was prepared, with the exception that the cocoa powder was replaced by the same proportion of a blend of cocoa powder and the product of Example 1, in which the product of Example 1 was present to the extent of 50% of the mixture.

The cereals were sampled by a tasting panel of 10 expert testers. The testers noted no difference in colour and all found the taste of the two batches of cereal to be substantially identical.

It should be understood that the embodiments described above are not only in the alternative, but can be combined.

1. A process for providing a cocoa replacer based on a material selected from roasted wheat, roasted and/or malted barley, comprising the steps of
(a) addition of the roasted wheat, roasted and/or malted barley to water at an initial temperature of at least 65° C. in an evaporation vessel;
(b) maintaining the initial temperature for at least 30 minutes;
(c) adding cold water; and
(d) immediately spray-drying the solution to give the cocoa replacer;
wherein the quantity of the water in step (a) is such that the weight of the roasted wheat, roasted and/or malted barley material comprises from 12-22% of the total weight of the material and the water, and the quantity of the water in step (c) comprises from 25-40% of the total quantity of the water used in the process.

2. The process according to claim 1, in which the weight of the roasted wheat, roasted and/or malted barley material in step (a) is from 14-18% of the total weight of the material and the water.

3. The process according to claim 1, in which the weight of the roasted wheat, roasted and/or malted barley material in the water in step (a) is from 15-17% the total weight of the material and the water.

4. The process according to claim 1, in which the quantity of the water in step (c) is from 25-35% by weight of the total quantity of the water used in the process.

5. The process according to claim 1, in which the quantity of the water in step (c) comprises from 28-32% of the total quantity of the water used in the process.

6. The process according to claim 1, in which the evaporation vessel is an open vessel.

7. The process according to claim 1, in which the evaporation vessel is a closed vessel with vacuum.

8. The process according to claim 1, in which there is added at step (d) at least one further flavour ingredient.

9. A cocoa replacer with reduced off-taste, prepared by the process according to claim 1.
